(19) United States
(12) Patent Application Publication
(10) Pub. No.: US 2020/0410394 A1
(43) Pub. Date: Dec. 31, 2020

(54) PREDICTING FUTURE ACTIONS DURING VISUAL DATA CLEANING

(71) Applicant: salesforce.com, inc., San Francisco, CA (US)

(72) Inventors: Lingtao ZHANG, Coquitlam (CA); Chang LU, Vancouver (CA); Amit KUMAR, Fremont, CA (US)

(21) Appl. No.: 16/455,142

(22) Filed: Jun. 27, 2019

(51) Int. Cl. G06N 20/00; G06N 5/02

(52) U.S. Cl. CPC G06N 20/00; G06N 5/02

(57) ABSTRACT

System and methods are described for visual data cleaning in a cloud computing environment. A method includes receiving a request for transformation of data values in cells of a selected column of a data set stored in a memory, applying the transformation on the selected column, if the selected column exists in a hierarchical relationship graph, determining zero or more columns of the data set affected by the transformation on the selected column according to the hierarchical relationship graph, and if there are one or more affected columns, predicting expected values for cells in the one or more affected columns according to a knowledge base.

### TECHNICAL FIELD

One or more implementations relate to preparation of data for input to analytics and machine learning applications, and more specifically to predicting future actions for data cleaning using a visual application in a cloud computing environment.

### BACKGROUND

“Cloud computing” services provide shared resources, software, and information to computers and other devices upon request or on demand. Cloud computing typically involves the over-the-Internet provision of dynamically-scalable and often virtualized resources. Technological details can be abstracted from end-users, who no longer have need for expertise in, or control over, the technology infrastructure “in the cloud” that supports them. In cloud computing environments, software applications can be accessible over the Internet rather than installed locally on personal or in-house computer systems. Some of the applications or on-demand services provided to end-users can include the ability for a user to create, view, modify, store and share documents and other files.

In a visual data cleaning application typically used for data preparation in a cloud computing environment, handling wide data sets with hundreds of different columns can be challenging. Cleaning data may involve reformatting and/or transforming the data to a desired format and fixing quality and/or consistency issues for subsequent analysis. For example, if the user has selected a column of data with multiple formats of phone numbers, one possible action is to reformat the data into a single format. However, columns may have semantic correlations with one another (for example, the following columns may have a high correlation: Address State, Address Country, Address City, and Address Zip Code). If a user were to clean the Address City column, by replacing “Los Angeles” to “Toronto” for example, this will result in a cascading effect to other columns that are highly correlated (e.g., state, zip code, and country should all be changed). Determining this correlation by the user is difficult when working with extra wide datasets and hundreds of columns, since there is no prediction mechanism to suggest additional data cleaning operations to perform after cleaning any given column. Instead, users must treat the data cleaning process as an iterative process, where different versions of the dataset are created and improved upon in each iteration. This iterative process is inefficient, consuming excessive time and storage.

### BRIEF DESCRIPTION OF THE DRAWINGS

The included drawings are for illustrative purposes and serve to provide examples of possible structures and operations for the disclosed inventive systems, apparatus, methods, and computer-readable storage media. These drawings in no way limit any changes in form and detail that may be made by one skilled in the art without departing from the spirit and scope of the disclosed implementations.

FIG. 1A illustrates an example computing environment of an on-demand database service such as a visual data cleaning application according to some embodiments.

FIG. 1B illustrates example implementations of elements of FIG. 1A and example interconnections between these elements according to some embodiments.

FIG. 2A illustrates example architectural components of an on-demand database service environment according to some embodiments.

FIG. 2B illustrates example architectural components of an on-demand database service environment according to some embodiments.

FIG. 3 is a diagrammatic representation of a machine in the exemplary form of a computer system within which one or more embodiments may be carried out.

FIG. 4 illustrates an example of a plurality of columns of data.

FIG. 5 illustrates an example of a data hierarchy.

FIG. 6 illustrates a computing environment according to some embodiments.

FIG. 7 is a diagram of a data prep session according to some embodiments.

FIG. 8 is a flow diagram of initialization processing according to some embodiments.

FIG. 9 is a flow diagram of prediction processing according to some embodiments.

FIG. 10 is a flow diagram of prediction processing according to some embodiments.

FIG. 11 is a flow diagram of prediction processing based on a knowledge base according to some embodiments.

FIG. 12 is a flow diagram of prediction processing based on statistical analysis according to some embodiments.

### DETAILED DESCRIPTION

Embodiments of the present invention predict what are the likely next visual data cleaning actions to be applied to a data set based on what the user has done to the data set in current and/or previous steps. In one scenario, a user accesses a file containing a data set (e.g., a spreadsheet file such as a “csv” file, for example) in a cloud computing system and prepares the data set for subsequent use such as presenting data analysis user interface dashboards or running reports. In some scenarios, the number of columns of data in the data set is large (e.g., perhaps tens or hundreds of columns) and may be difficult and/or unwieldy to represent on a display to the user operating a customer device such as a laptop computer, a desktop computer, a tablet computer, and a smart phone, for example. When the user opens the data set to prepare the data for future use, embodiments of the present invention perform a correlation analysis on data in a plurality of the columns of the data set to determine correlations of the data between columns through two approaches applied in parallel.

A knowledge base approach is applied to the data set to detect a meaning of the type of data in each column and categorize each column into one of a plurality of known data subtypes (such as state, country, phone number, email address, zip code, date, ID number, age, gender, product number, product category, manufacturing location, production cost, sales price, and so on). Once the columns are categorized into subtypes, embodiments of the present invention construct a hierarchy view of the data set based at least in part on the meaning of the types of data in the columns (for example, cities are linked to a state, which are then linked to a country, and so on).

A mathematical approach is applied to the data set by running a statistical analysis of the data in a plurality of columns (such as chi square, for example) to determine a correlation score between any two given columns. Once a high correlation score is detected between data in columns, simple regression models are constructed in the background to be used for predicting data values between the columns. In one embodiment, a high correlation is any percentage greater than 50%. The correlation threshold is implementation dependent, and in some embodiments may be set by the user to a percentage in the range 0% to 100%.

Once the user has selected a column and has directed a transformation action to be applied to the column (such as search and replace, bucketing, etc.), embodiments of the present invention apply the transformation to data of the column and determine what other columns are affected by the change based on the hierarchy view and the statistical linkage. If a strong correlation is found, embodiments of the present invention suggest a course of action to the user for columns that the user should clean next. In one embodiment, a strong relationship is categorized as 0.7 or higher. For example, in an example replacing “Los Angeles” with “Toronto” in a particular cell of a column for a city data field, embodiments of the present invention suggest a cell in a “state/province” column to the user to be cleaned with the corrected value filled in because embodiments of the present invention are able to derive the correct value from a knowledge base of known cities, state/provinces, countries, etc. In the case where only a statistical correlation is detected, and there is no known hierarchy (for example, between user identifier (ID) and age columns), embodiments of the present invention suggest to the user to use a result of a predictive model to predict data values for cells of another column with a very high correlation (such as 0.9 for example). Even in the case wherein no appropriate suggestion can be determined for the next data cleaning action, indicating columns that may be affected by the current data cleaning action to the user can be useful information when cleaning a wide data set.

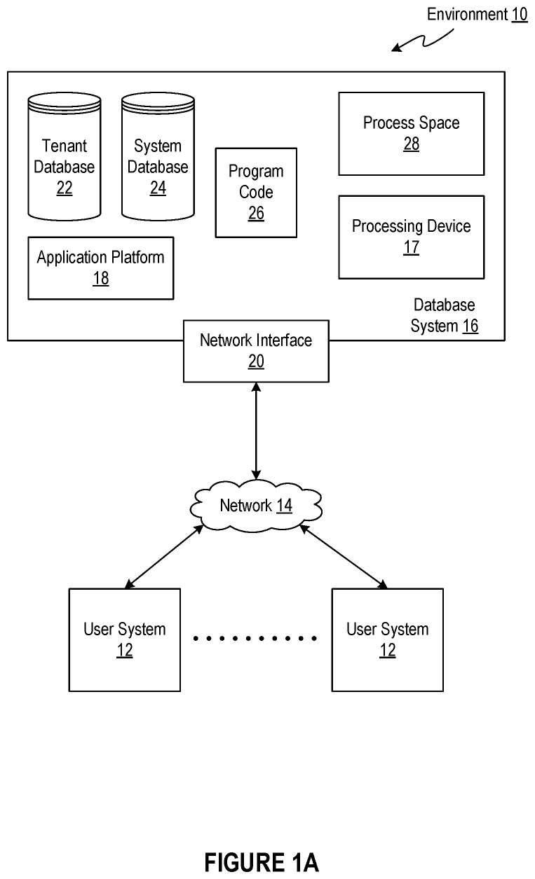

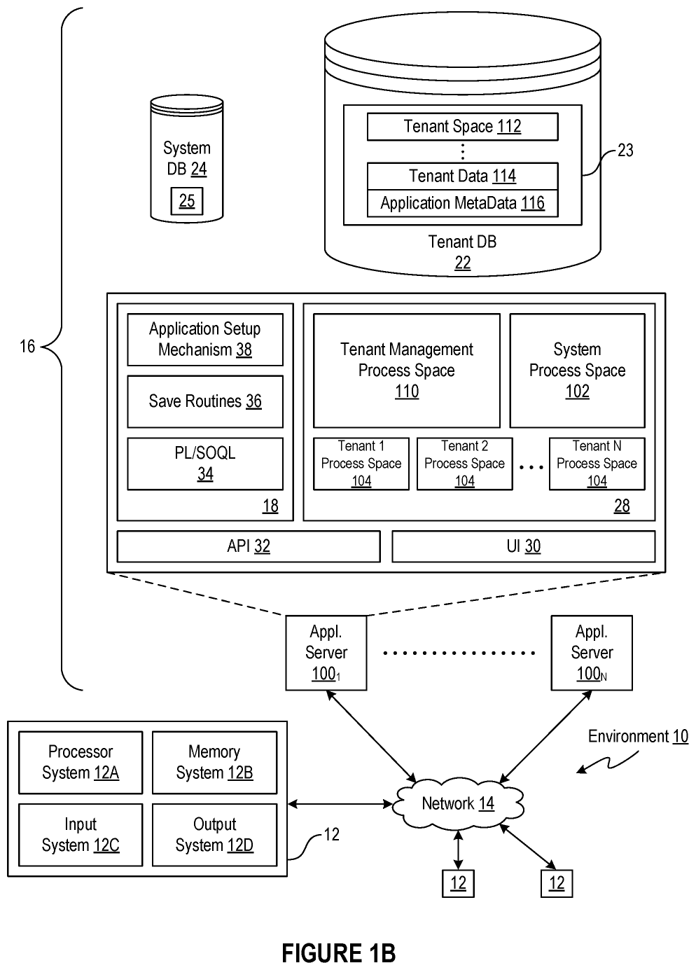

FIG. 1A illustrates a block diagram of an example of a cloud computing environment 10 in which an on-demand database service such as a visual data cleaning application can be used in accordance with some implementations. Environment 10 includes user systems 12 (e.g., customer's computing systems), a network 14, a database system 16 (also referred to herein as a “cloud-based system” or a “cloud computing system”), a processing device 17, an application platform 18, a network interface 20, a tenant database 22 for storing tenant data (such as data sets), a system database 24 for storing system data, program code 26 for implementing various functions of the database system 16 (including a visual data cleaning application), and process space 28 for executing database system processes and tenant-specific processes, such as running applications for customers as part of an application hosting service. In some other implementations, environment 10 may not have all of these components or systems, or may have other components or systems instead of, or in addition to, those listed above.

In some implementations, environment 10 is a computing environment in which an on-demand database service (such as a visual data cleaning application) exists. An on-demand database service, such as that which can be implemented using database system 16, is a service that is made available to users outside an enterprise (or enterprises) that owns, maintains, or provides access to database system 16. As described above, such users generally do not need to be concerned with building or maintaining database system 16. Instead, resources provided by database system 16 may be available for such users' use when the users need services provided by database system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a large number of customers, and a given database table may store rows of data for a potentially much larger number of customers. A database image can include one or more database objects. A relational database management system (RDBMS) or the equivalent can execute storage and retrieval of information against the database object(s).

Application platform 18 can be a framework that allows the applications of database system 16 to execute, such as the hardware or software infrastructure of database system 16. In some implementations, application platform 18 enables the creation, management and execution of one or more applications developed by the provider of the on-demand database service, users accessing the on-demand database service via user systems 12, or third-party application developers accessing the on-demand database service via user systems 12.

In some implementations, database system 16 implements a web-based customer relationship management (CRM) system. For example, in some such implementations, database system 16 includes application servers configured to implement and execute CRM software applications as well as provide related data, code, forms, renderable web pages, and documents and other information to and from user systems 12 and to store to, and retrieve from, a database system related data, objects, and World Wide Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. Database system 16 also implements applications other than, or in addition to, a CRM application. For example, database system 16 can provide tenant access to multiple hosted (standard and custom) applications, including a CRM application. User (or third-party developer) applications, which may or may not include CRM, may be supported by application platform 18. Application platform 18 manages the creation and storage of the applications into one or more database objects and the execution of the applications in one or more virtual machines in the process space of database system 16.

According to some implementations, each database system 16 is configured to provide web pages, forms, applications, data, and media content to user (client) systems 12 to support the access by user systems 12 as tenants of database system 16. As such, database system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application, such as an object-oriented database management system (OODBMS) or a relational database management system (RDBMS), as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

Network 14 can be or include any network or combination of networks of systems or devices that communicate with one another. For example, network 14 can be or include any one or any combination of a local area network (LAN), wide area network (WAN), telephone network, wireless network, cellular network, point-to-point network, star network, token ring network, hub network, or other appropriate configuration. Network 14 can include a Transfer Control Protocol and Internet Protocol (TCP/IP) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

User systems 12 (e.g., operated by customers) can communicate with database system 16 using TCP/IP and, at a higher network level, other common Internet protocols to communicate, such as the Hyper Text Transfer Protocol (HTTP), Hyper Text Transfer Protocol Secure (HTTPS), File Transfer Protocol (FTP), Apple File Service (AFS), Wireless Application Protocol (WAP), etc. In an example where HTTP is used, each user system 12 can include an HTTP client commonly referred to as a “web browser” or simply a “browser” for sending and receiving HTTP signals to and from an HTTP server of the database system 16. Such an HTTP server can be implemented as the sole network interface 20 between database system 16 and network 14, but other techniques can be used in addition to or instead of these techniques. In some implementations, network interface 20 between database system 16 and network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

User systems 12 can be implemented as any computing device(s) or other data processing apparatus or systems usable by users to access database system 16. For example, any of user systems 12 can be a desktop computer, a work station, a laptop computer, a tablet computer, a handheld computing device, a mobile cellular phone (for example, a “smartphone”), or any other Wi-Fi-enabled device, WAP-enabled device, or other computing device capable of interfacing directly or indirectly to the Internet or other network. When discussed in the context of a user, the terms “user system,” “user device,” and “user computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, Google's Chrome browser, or a WAP-enabled browser in the case of a cellular phone, personal digital assistant (PDA), or other wireless device, allowing a user (for example, a subscriber of on-demand services provided by database system 16) of user system 12 to access, process, and view information, pages, and applications available to it from database system 16 over network 14.

Each user system 12 also typically includes one or more user input devices, such as a keyboard, a mouse, a trackball, a touch pad, a touch screen, a pen or stylus, or the like, for interacting with a graphical user interface (GUI) provided by the browser on a display (for example, a monitor screen, liquid crystal display (LCD), light-emitting diode (LED) display, etc.) of user system 12 in conjunction with pages, forms, applications, and other information provided by database system 16 or other systems or servers. For example, the user interface device can be used to access data and applications hosted database system 16, and to perform searches on stored data, or otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with database system 16, that user system can have the capacities allotted to the salesperson. However, while an administrator is using that user system 12 to interact with database system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU), such as a Core® processor commercially available from Intel Corporation or the like. Similarly, database system 16 (and additional instances of an MTS, where more than one is present) and all of its components can be operator-configurable using application(s) including computer code to run using processing device 17, which may be implemented to include a CPU, which may include an Intel Core® processor or the like, or multiple CPUs. Each CPU may have multiple processing cores.

Database system 16 includes non-transitory computer-readable storage media having instructions stored thereon that are executable by or used to program a server or other computing system (or collection of such servers or computing systems) to perform some of the implementation of processes described herein. For example, program code 26 can include instructions for operating and configuring database system 16 to intercommunicate and to process web pages, applications (including visual data cleaning applications), and other data and media content as described herein. In some implementations, program code 26 can be downloadable and stored on a hard disk, but the entire program code, or portions thereof, also can be stored in any other volatile or non-volatile memory medium or device as is well known, such as a read-only memory (ROM) or random-access memory (RAM), or provided on any media capable of storing program code, such as any type of rotating media including floppy disks, optical discs, digital video discs (DVDs), compact discs (CDs), micro-drives, magneto-optical discs, magnetic or optical cards, nanosystems (including molecular memory integrated circuits), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, virtual private network (VPN), local area network (LAN), etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VB Script, and many other programming languages as are well known.

FIG. 1B illustrates a block diagram of example implementations of elements of FIG. 1A and example interconnections between these elements according to some implementations. That is, FIG. 1B also illustrates environment 10, but in FIG. 1B, various elements of database system 16 and various interconnections between such elements are shown with more specificity according to some more specific implementations. In some implementations, database system 16 may not have the same elements as those described herein or may have other elements instead of, or in addition to, those described herein.

In FIG. 1B, user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, network interface 20 is implemented as a set of HTTP application servers 1001-100N. Each application server 100, also referred to herein as an “app server,” is configured to communicate with tenant database 22 and tenant data 23 stored therein, as well as system database 24 and system data 25 stored therein, to serve requests received from user systems 12. Tenant data 23 can be divided into individual tenant storage spaces 112, which can be physically or logically arranged or divided. Within each tenant storage space 112, tenant data 114 and application metadata 116 can similarly be allocated for each user. For example, a copy of a user's most recently used (MRU) items can be stored in tenant data 114. Similarly, a copy of MRU items for an entire organization that is a tenant can be stored to tenant space 112.

Database system 16 of FIG. 1B also includes a user interface (UI) 30 and an application programming interface (API) 32. Process space 28 includes system process space 102, individual tenant process spaces 104 and a tenant management process space 110. Application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process space 110, for example. Invocations to such applications can be coded using procedural language for structured query language (PL/SQL) 34, which provides a programming language style interface extension to the API 32. A detailed description of some PL/SQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, issued on Jun. 1, 2010, and hereby incorporated by reference herein in its entirety and for all purposes. Invocations to applications can be detected by one or more system processes, which manage retrieving application metadata 116 for the subscriber making the invocation and executing the metadata as an application in a virtual machine.

Each application server 100 can be communicably coupled with tenant database 22 and system database 24, for example, having access to tenant data 23 and system data 25, respectively, via a different network connection. For example, one application server 1001 can be coupled via the network 14 (for example, the Internet), another application server 1002 can be coupled via a direct network link, and another application server 100N can be coupled by yet a different network connection. Transfer Control Protocol and Internet Protocol (TCP/IP) are examples of typical protocols that can be used for communicating between application servers 100 and database system 16. However, it will be apparent to one skilled in the art that other transport protocols can be used to optimize database system 16 depending on the network interconnections used.

In some implementations, each application server 100 is configured to handle requests for any user associated with any organization that is a tenant of database system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between application servers 100 and user systems 12 to distribute requests to application servers 100. In one implementation, the load balancer uses a least-connections algorithm to route user requests to application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, database system 16 can be a multi-tenant system in which database system 16 handles storage of, and access to, different objects, data, and applications across disparate users and organizations.

In one example storage use case, one tenant can be a company that employs a sales force where each salesperson uses database system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed database system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, database system 16 also can maintain system level data usable by multiple tenants or other data. Such system level data can include industry reports, news, postings, and the like that are sharable among tenants.

In some implementations, user systems 12 (which also can be client systems) communicate with application servers 100 to request and update system-level and tenant-level data from database system 16. Such requests and updates can involve sending one or more queries to tenant database 22 or system database 24. Database system 16 (for example, an application server 100 in database system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, issued on Aug. 17, 2010, and hereby incorporated by reference herein in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

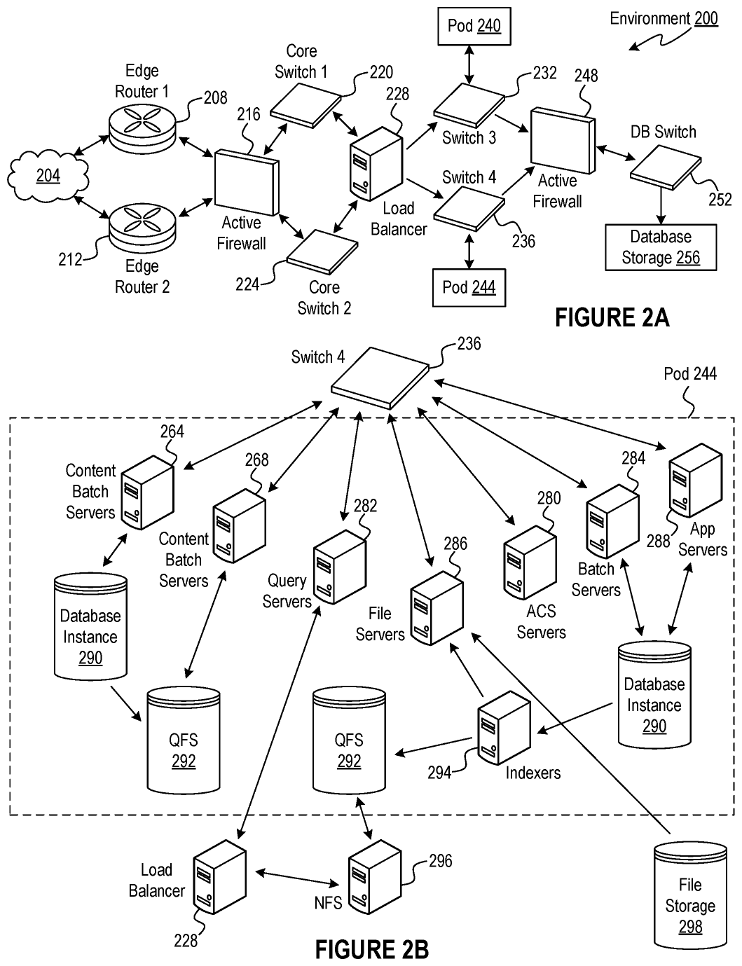

FIG. 2A shows a system diagram illustrating example architectural components of an on-demand database service environment 200 according to some implementations. A client machine communicably connected with the cloud 204, generally referring to one or more networks in combination, as described herein, can communicate with the on-demand database service environment 200 via one or more edge routers 208 and 212. A client machine can be any of the examples of user systems 12 described above. The edge routers can communicate with one or more core switches 220 and 224 through a firewall 216. The core switches can communicate with a load balancer 228, which can distribute server load over different pods, such as the pods 240 and 244. Pods 240 and 244, which can each include one or more servers or other computing resources, can perform data processing and other operations used to provide on-demand services. Communication with the pods can be conducted via pod switches 232 and 236. Components of the on-demand database service environment can communicate with database storage 256 through a database firewall 248 and a database switch 252.

As shown in FIGS. 2A and 2B, accessing an on-demand database service environment can involve communications transmitted among a variety of different hardware or software components. Further, the on-demand database service environment 200 is a simplified representation of an actual on-demand database service environment. For example, while only one or two devices of each type are shown in FIGS. 2A and 2B, some implementations of an on-demand database service environment can include anywhere from one to many devices of each type. Also, the on-demand database service environment need not include each device shown in FIGS. 2A and 2B, or can include additional devices not shown in FIGS. 2A and 2B.

Additionally, it should be appreciated that one or more of the devices in the on-demand database service environment 200 can be implemented on the same physical device or on different hardware. Some devices can be implemented using hardware or a combination of hardware and software. Thus, terms such as “data processing apparatus,” “machine,” “server,” “device,” and “processing device” as used herein are not limited to a single hardware device; rather, references to these terms can include any suitable combination of hardware and software configured to provide the described functionality.

Cloud 204 is intended to refer to a data network or multiple data networks, often including the Internet. Client machines communicably connected with cloud 204 can communicate with other components of the on-demand database service environment 200 to access services provided by the on-demand database service environment. For example, client machines can access the on-demand database service environment to retrieve, store, edit, or process information. In some implementations, edge routers 208 and 212 route packets between cloud 204 and other components of the on-demand database service environment 200. For example, edge routers 208 and 212 can employ the Border Gateway Protocol (BGP). The BGP is the core routing protocol of the Internet. Edge routers 208 and 212 can maintain a table of Internet Protocol (IP) networks or ‘prefixes,’ which designate network reachability among autonomous systems on the Internet.

In some implementations, firewall 216 can protect the inner components of the on-demand database service environment 200 from Internet traffic. Firewall 216 can block, permit, or deny access to the inner components of on-demand database service environment 200 based upon a set of rules and other criteria. Firewall 216 can act as one or more of a packet filter, an application gateway, a stateful filter, a proxy server, or any other type of firewall.

In some implementations, core switches 220 and 224 are high-capacity switches that transfer packets within the on-demand database service environment 200. Core switches 220 and 224 can be configured as network bridges that quickly route data between different components within the on-demand database service environment. In some implementations, the use of two or more core switches 220 and 224 can provide redundancy or reduced latency.

In some implementations, pods 240 and 244 perform the core data processing and service functions provided by the on-demand database service environment. Each pod can include various types of hardware or software computing resources. An example of the pod architecture is discussed in greater detail with reference to FIG. 2B. In some implementations, communication between pods 240 and 244 is conducted via pod switches 232 and 236. Pod switches 232 and 236 can facilitate communication between pods 240 and 244 and client machines communicably connected with cloud 204, for example, via core switches 220 and 224. Also, pod switches 232 and 236 may facilitate communication between pods 240 and 244 and database storage 256. In some implementations, load balancer 228 can distribute workload between pods 240 and 244. Balancing the on-demand service requests between the pods can assist in improving the use of resources, increasing throughput, reducing response times, or reducing overhead. Load balancer 228 may include multilayer switches to analyze and forward traffic.

In some implementations, access to database storage 256 is guarded by a database firewall 248. Database firewall 248 can act as a computer application firewall operating at the database application layer of a protocol stack. Database firewall 248 can protect database storage 256 from application attacks such as SQL injection, database rootkits, and unauthorized information disclosure. In some implementations, database firewall 248 includes a host using one or more forms of reverse proxy services to proxy traffic before passing it to a gateway router. Database firewall 248 can inspect the contents of database traffic and block certain content or database requests. Database firewall 248 can work on the SQL application level atop the TCP/IP stack, managing applications' connection to the database or SQL management interfaces as well as intercepting and enforcing packets traveling to or from a database network or application interface.

In some implementations, communication with database storage 256 is conducted via database switch 252. Multi-tenant database storage 256 can include more than one hardware or software components for handling database queries. Accordingly, database switch 252 can direct database queries transmitted by other components of the on-demand database service environment (for example, pods 240 and 244) to the correct components within database storage 256. In some implementations, database storage 256 is an on-demand database system shared by many different organizations as described above with reference to FIGS. 1A and 1B.

FIG. 2B shows a system diagram further illustrating example architectural components of an on-demand database service environment according to some implementations. Pod 244 can be used to render services to a user of on-demand database service environment 200. In some implementations, each pod includes a variety of servers or other systems. Pod 244 includes one or more content batch servers 264, content search servers 268, query servers 282, file servers 286, access control system (ACS) servers 280, batch servers 284, and app servers 288. Pod 244 also can include database instances 290, quick file systems (QFS) 292, and indexers 294. In some implementations, some or all communication between the servers in pod 244 can be transmitted via pod switch 236.

In some implementations, app servers 288 include a hardware or software framework dedicated to the execution of procedures (for example, programs, routines, scripts) for supporting the construction of applications provided by on-demand database service environment 200 via pod 244. In some implementations, the hardware or software framework of an app server 288 is configured to execute operations of the services described herein, including performance of the blocks of various methods or processes described herein. In some alternative implementations, two or more app servers 288 can be included and cooperate to perform such methods, or one or more other servers described herein can be configured to perform the disclosed methods.

Content batch servers 264 can handle requests internal to the pod. Some such requests can be long-running or not tied to a particular customer. For example, content batch servers 264 can handle requests related to log mining, cleanup work, and maintenance tasks. Content search servers 268 can provide query and indexer functions. For example, the functions provided by content search servers 268 can allow users to search through content stored in the on-demand database service environment. File servers 286 can manage requests for information stored in file storage 298. File storage 298 can store information such as documents, images, and binary large objects (BLOBs). By managing requests for information using file servers 286, the image footprint on the database can be reduced. Query servers 282 can be used to retrieve information from one or more file systems. For example, query servers 282 can receive requests for information from app servers 288 and transmit information queries to network file systems (NFS) 296 located outside the pod.

Pod 244 can share a database instance 290 configured as a multi-tenant environment in which different organizations share access to the same database. Additionally, services rendered by pod 244 may call upon various hardware or software resources. In some implementations, ACS servers 280 control access to data, hardware resources, or software resources. In some implementations, batch servers 284 process batch jobs, which are used to run tasks at specified times. For example, batch servers 284 can transmit instructions to other servers, such as app servers 288, to trigger the batch jobs.

In some implementations, QFS 292 is an open source file system available from Sun Microsystems, Inc. The QFS can serve as a rapid-access file system for storing and accessing information available within the pod 244. QFS 292 can support some volume management capabilities, allowing many disks to be grouped together into a file system. File system metadata can be kept on a separate set of disks, which can be useful for streaming applications where long disk seeks cannot be tolerated. Thus, the QFS system can communicate with one or more content search servers 268 or indexers 294 to identify, retrieve, move, or update data stored in NFS 296 or other storage systems.

In some implementations, one or more query servers 282 communicate with the NFS 296 to retrieve or update information stored outside of the pod 244. NFS 296 can allow servers located in pod 244 to access information to access files over a network in a manner similar to how local storage is accessed. In some implementations, queries from query servers 282 are transmitted to NFS 296 via load balancer 228, which can distribute resource requests over various resources available in the on-demand database service environment. NFS 296 also can communicate with QFS 292 to update the information stored on NFS 296 or to provide information to QFS 292 for use by servers located within pod 244.

In some implementations, the pod includes one or more database instances 290. Database instance 290 can transmit information to QFS 292. When information is transmitted to the QFS, it can be available for use by servers within pod 244 without using an additional database call. In some implementations, database information is transmitted to indexer 294. Indexer 294 can provide an index of information available in database instance 290 or QFS 292. The index information can be provided to file servers 286 or QFS 292.

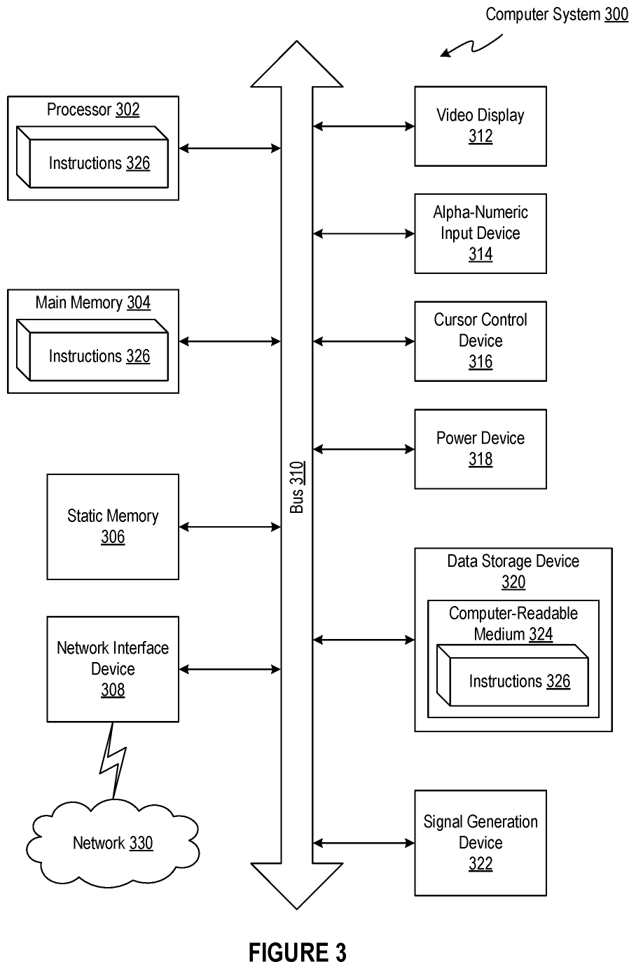

FIG. 3 illustrates a diagrammatic representation of a machine in the exemplary form of a computer system 300 within which a set of instructions (e.g., for causing the machine to perform any one or more of the methodologies discussed herein) may be executed. In alternative implementations, the machine may be connected (e.g., networked) to other machines in a LAN, a WAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a PDA, a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 300 may be utilized by or illustrative of any of the electronic components described herein (e.g., any of the components illustrated in or described with respect to FIGS. 1A, 1B, 2A, and 2B).

The exemplary computer system 300 includes a processing device (processor) 302, a main memory 304 (e.g., ROM, flash memory, dynamic random access memory (DRAM) such as synchronous DRAM (SDRAM) or Rambus DRAM (RDRAM), etc.), a static memory 306 (e.g., flash memory, static random access memory (SRAM), etc.), and a data storage device 320, which communicate with each other via a bus 310.

Processor 302 represents one or more general-purpose processing devices such as a microprocessor, central processing unit, or the like. More particularly, processor 302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 302 may also be one or more special-purpose processing devices such as an application specific integrated circuit (ASIC), a field programmable gate array (FPGA), a digital signal processor (DSP), network processor, or the like. Processor 302 is configured to execute instructions 326 for performing the operations and steps discussed herein. Processor 302 may have one or more processing cores.

Computer system 300 may further include a network interface device 308. Computer system 300 also may include a video display unit 312 (e.g., a liquid crystal display (LCD), a cathode ray tube (CRT), or a touch screen), an alphanumeric input device 314 (e.g., a keyboard), a cursor control device 316 (e.g., a mouse or touch screen), and a signal generation device 322 (e.g., a loud speaker).

Power device 318 may monitor a power level of a battery used to power computer system 300 or one or more of its components. Power device 318 may provide one or more interfaces to provide an indication of a power level, a time window remaining prior to shutdown of computer system 300 or one or more of its components, a power consumption rate, an indicator of whether computer system is utilizing an external power source or battery power, and other power related information. In some implementations, indications related to power device 318 may be accessible remotely (e.g., accessible to a remote back-up management module via a network connection). In some implementations, a battery utilized by power device 318 may be an uninterruptable power supply (UPS) local to or remote from computer system 300. In such implementations, power device 318 may provide information about a power level of the UPS.

Data storage device 320 may include a computer-readable storage medium 324 (e.g., a non-transitory computer-readable storage medium) on which is stored one or more sets of instructions 326 (e.g., software) embodying any one or more of the methodologies or functions described herein. Instructions 326 may also reside, completely or at least partially, within main memory 304 and/or within processor 302 during execution thereof by computer system 300, main memory 304, and processor 302 also constituting computer-readable storage media. Instructions 326 may further be transmitted or received over a network 330 (e.g., network 14) via network interface device 308.

In one implementation, instructions 326 include instructions for performing any of the implementations described herein. While computer-readable storage medium 324 is shown in an exemplary implementation to be a single medium, it is to be understood that computer-readable storage medium 324 may include a single medium or multiple media (e.g., a centralized or distributed database, and/or associated caches and servers) that store the one or more sets of instructions.

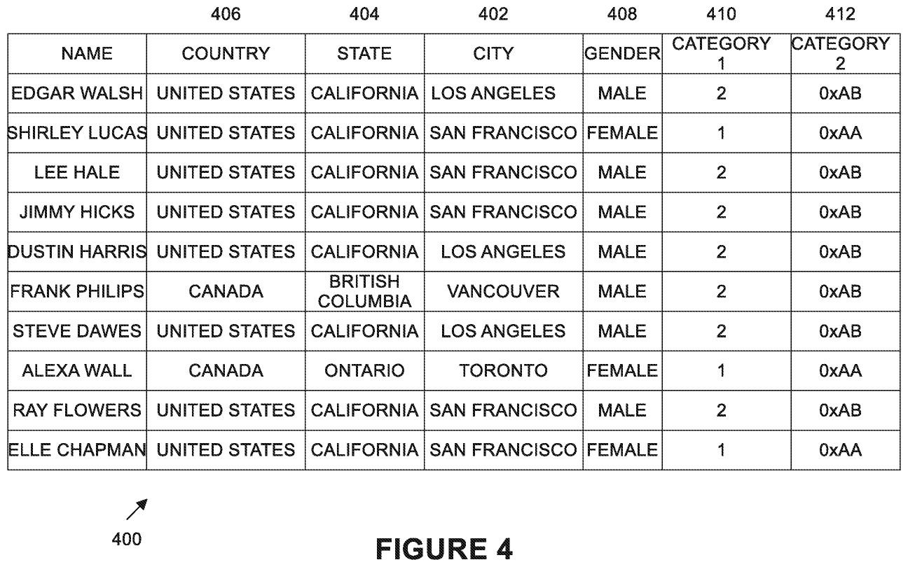

FIG. 4 illustrates an example 400 of a plurality of columns of data in a data set. For example, the columns of data may be a portion of tenant data 114 of FIG. 1B and/or tenant database 22 of FIG. 1A selected by a user via a user interface. At least a portion of the user-selected columns are displayed to the user on a display. Although seven columns are shown in this simple example, it should be understood that the number of columns in tenant data 114, the number of columns shown on a display, and the number of columns selected by the user for cleaning may be any natural number. In this example, the user may desire to clean the data in selected columns using a visual data cleaning application (e.g., program code 26 of FIG. 1A). The visual data cleaning application displays at least some of the selected columns and provides available commands that the user can call and/or select to clean the data in selected columns.

In some embodiments, there are data transformations available to be selected by the user to be applied to the data in one or more columns. Examples of data transformations to be applied to a selected one or more columns of data include upper case, lower case, search and replace, trim, split by a given number (string or character), substring, convert string to number, convert number to string, extract date information (extract month, day, year, hour, minute, second, etc.), join another data set, append another data set, pivot/unpivot, aggregation, string concatenation, predicting missing value, numerical bucketing, text bucketing, data bucketing, and others.

In one example, a user may search and replace on the City column 402 and change “Vancouver” to “San Francisco” for a customer named Frank Philips. In this example, embodiments of the present invention apply the knowledge base approach to automatically determine a recommendation to change “British Columbia” to “California” in State column 404 and change “Canada” to “United States” in column 406, based at least in part on the meaning of the data in columns 402, 404, and 406 and their relationship (e.g., a known hierarchy of city, state, and country data values).

In another example, the user may search and replace on the gender column 408 and change “Male” to “Female” for a customer named Lee Hale. In this example, embodiments of the present invention apply a statistical approach to provide the user with suggestions to change the data value in column Category 1 410 for Lee Hale from “2” to “1” and the data value in column Category 2 412 for Lee Hale from “0xAB” to “0xAA”, based at least in part on the correlation between the Gender 408, Category 1 410, and Category 2 412 columns as determined by statistical analysis.

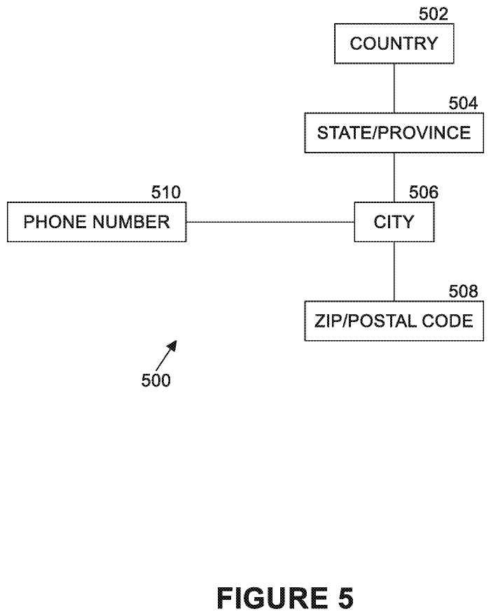

FIG. 5 illustrates an example of a data hierarchy 500. In this simple example, a data value of a data set indicating a City 506 has known relationships according to a knowledge base with other data values in the data set. For example, City 506 is associated with a State/Province 504, which is associated with a Country 502. The City is also associated with a Zip/Postal Code 508. Further, a Phone Number 510 (as indicated by an area code) has a relationship with City 506.

In one scenario, a user may modify a data value in Country column 406. Assuming there is a State column 404 in the data set, embodiments of the present invention verify that for all cells in Country column 406 after the transformation, corresponding data values are still stored in cells in State column 404 (e.g., if the Country data value is changed from “Canada” to “United States”, the associated State/Province data value should reflect the change to specify a state from the USA, not a province from Canada). Embodiments of the present invention detect the anomaly and highlight the anomaly for corrective action by the user.

In another scenario, the user may modify a data value in City column 402. Assuming there is a State column 404 in the data set, embodiments of the present invention verify that for all cells in City column 402 after the transformation, corresponding data values are still stored in cells in State column 404 (e.g., if the City data value is changed from “Los Angeles” to “Phoenix”, the associated State/Province data value should reflect the change to specify “Arizona”, not “California”). Embodiments of the present invention detect the anomaly and suggest a correct value for action by the user (e.g., an indication of the correct state in this example).

In yet another scenario, the user may modify a data value for a Phone Number column 510 (for example, changing the area code of one or more cells in Phone Number column 510). Assuming there is a City column 506 in the data set, embodiments of the present invention verify that for all cells in the Phone Number column 510 after the transformation, corresponding data values are still stored in cells in City column 402 (e.g., if the phone number data value is changed from “310-555-5555” to “480-555-5555”, the associated City data value should reflect the change to specify “Phoenix”, not “Los Angeles”). Embodiments of the present invention detect the anomaly and suggest a correct value for action to be taken by the user (e.g., an indication of the correct city in this example) if there is a one to one relationship between the columns (e.g., phone number and city). If there is not a one to one relationship between the columns, then embodiments of the present invention highlight the mismatch for the user to take corrective action.

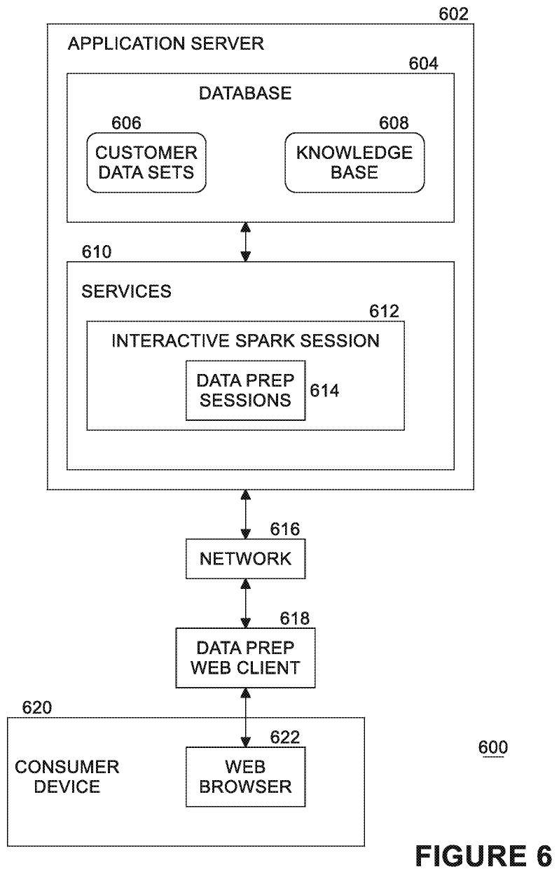

FIG. 6 illustrates a computing environment 600 according to some embodiments. Application server 602 (e.g., application server 100 of FIG. 1B) provides cloud computing services over network 616 (e.g., network 14 of FIG. 1A) to a user operating a consumer device 620 (e.g., user system 12 of FIG. 1A). Consumer device runs web browser 622. Application server 602 includes a database 604 (e.g., tenant database 22 of FIG. 1A) and provides one or more services 610. Services 610 include any function useful to the user. Database 604 includes one or more customer data sets 606 and at least one knowledge base 608. Although at least one knowledge database 608 is shown as integral to database 604, in other embodiments the at least one knowledge base may be accessible by application server 602 over network 615 (e.g., accessible from another computer system over the Internet). Customer data sets 606 include any information useful to a customer/consumer/user. In some embodiments, each data set 606 include many columns of data. Knowledge base 608 includes any information describing semantic relationships between data set columns. For example, a knowledge base could include census data for each country, state, city, phone with area code, zip codes, population data, and so on. In another example, a knowledge base could include a Universal Product Code (UPC) with product name, description, product categories, and so on.

Services 610 include an interactive communications session for consumer device 620 (operated by the user) to interact with data in customer data sets 606. In some embodiments, the interactive session includes an interactive Spark Session. Apache Spark is an open source distributed general-purpose cluster computing framework provided by the Apache Software Foundation. Spark provides an interface for programming entire clusters with implicit data parallelism and fault tolerance. A Spark Session provides a single point of entry for the user to interact with underlying Spark functionality and allows programming Spark with DataFrame and Dataset application programming interfaces (APIs). In some embodiments, interactive Spark Session 612 includes one or more data prep sessions 614. Data prep sessions provide the functionality of a visual data cleaning application allowing the user to clean data in customer data sets 606 prior to use by other applications (e.g., analysis dashboards, report generators, etc.). Application server 602 may support large numbers of simultaneous data prep sessions and/or access to large numbers of customer data sets (e.g., hundreds, thousands, tens of thousands, and so on).

Data prep web client 618 provides an interface between web browser 622 running on consumer device 620 and data prep sessions 614 running on application server 602. In some embodiments, data prep web client runs on consumer device 620.

Upon a request by the user, data prep web client 618 initializes an interactive Spark session 614 and identifies a customer data set 606 by a database identifier (ID). In response, interactive Spark session 612 creates a new data prep session 614. After the new data prep session is created, data prep session 614 returns a sample data payload from the selected customer data set 606 to interactive Spark session 612, which forwards the sample data payload to data prep web client 618. Data prep web client 618 displays the sample data payload via web browser 622 to the user. The user may then request a first transformation to be applied to one or more selected columns of the selected customer data set 606. Data prep session 614 processes the first transformation request and returns a suggested second transformation for affected columns to correct anomalies introduced by application of the user's first transformation request to data prep web client 618 via interactive Spark session 612. The user may then approve the suggested second transformation for affected columns. Data prep session 614 processes the second transformation request and results are displayed to the user. The user may approve the second transformation on affected columns and may optionally create a new customer data set 606 based on the first and second transformations. These actions may be repeated. After all user requests for a session are processed, session data may be written to database 604 (e.g., to long term storage on disk) and any newly created customer datasets 606 are stored in database 604. Database 604 may return a new unique database ID for a newly created customer dataset to data prep session 614. Data prep session 614 may return the database ID to data prep web client 618 via interactive Spark session 612 for possible future use by the user and terminate the session.

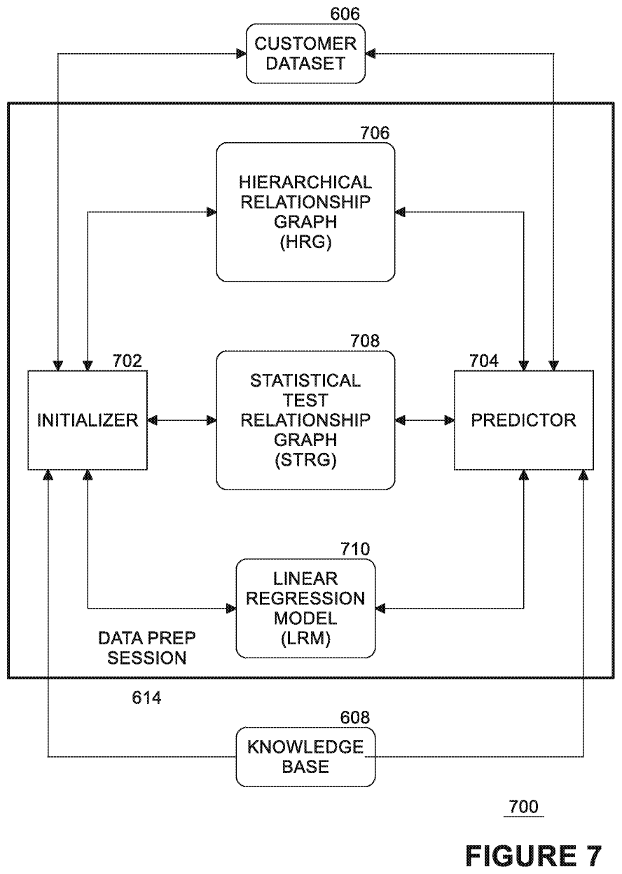

FIG. 7 is a diagram 700 of a data prep session 614 according to some embodiments. Data prep session 614 includes at least five components. Initializer 702 loads a selected one or more datasets 606 and at least one knowledge base 608 into memory, classifies data subtypes for columns of datasets by comparing the columns to knowledge base 608, constructs a hierarchical relationship graph (HRG) 706 between each column subtype using knowledge base 608, runs statistical tests to calculate correlation scores among columns, constructs a statistical test relationship graph (STRG) 708 for each column, and trains a linear regression model (LRM) 710 for highly correlated columns. Predictor 704 applies a first transformation to one or more columns selected by the user based on a user request and determines columns affected by the first transformation using hierarchical relationship graph 706 and statistical test relationship graph 708. If a relationship between columns exists in hierarchical relationship graph 706, predictor 706 returns results according to the hierarchical relationship graph, detects anomalies between columns using knowledge base 608, and suggests a second transformation to correct the anomalies. Predictor 704 may receive approval of the second transformation from the user. If the second transformation is approved, Predictor 704 applies the second transformation to selected columns. Predictor 704 determines columns affected by the second transformation using hierarchical relationship graph 706 and statistical test relationship graph 708. If a relationship between columns exists only in statistical test relationship graph 708 with in one embodiment a correlation score >90%, then Predictor 704 runs linear regression model 710 on mutated cells of columns indicated by the statistical test relationship graph. Predictor 704 then uses predicted values from the linear regression model 710 to create a suggested third transformation. In an embodiment, the third transformation is a search and replace transformation. Predictor sends the third transformation to the data prep web client for approval by the user. If the user approves, Predictor 704 applies the third transformation.

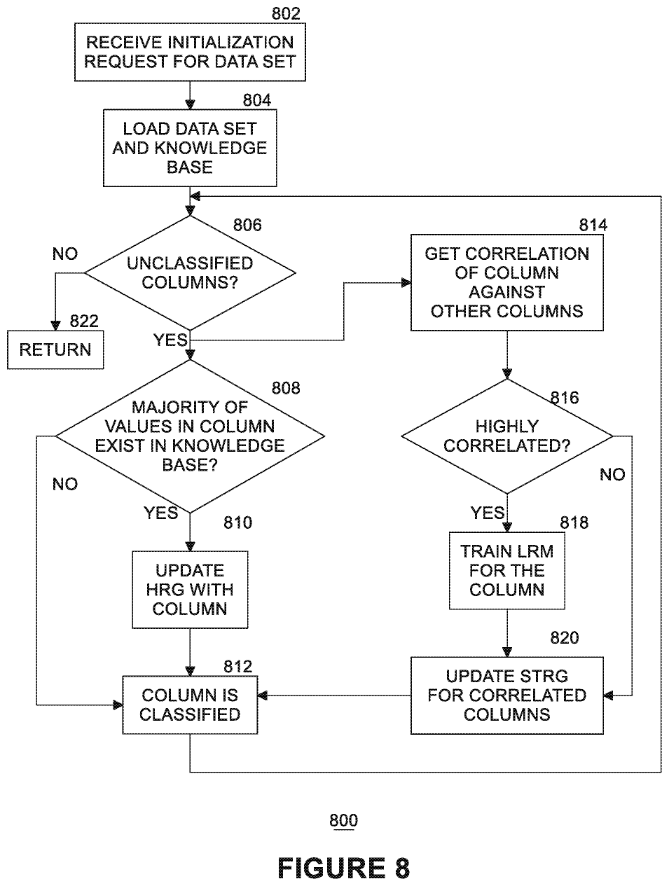

FIG. 8 is a flow diagram 800 of initialization processing according to some embodiments. In an embodiment, the actions of flow diagram 800 are performed by initializer 702 of data prep session 614. At block 802, Initializer 702 receives an initialization request for a customer data set 606. At block 804, Initializer loads the customer data set and knowledge base 608 into memory 304 in application server 602. Initializer 702 processes all columns of the data set, beginning with the first column. At block 806 if there are still unclassified columns of the data set, processing continues with a currently selected column of the data set at block 808. If at block 808 in one embodiment a majority of data values in the current column exist in knowledge base 608, Initializer 702 at block 810 updates a hierarchical relationship graph (HRG) 706 for the data set with the current column. In one embodiment, using a majority (e.g., more than 50%) as a threshold provides the results of the present system with better results than thresholds lower than 50%. In an embodiment, the threshold is set by the user. The column is considered classified at block 812. Processing continues with a next column of the data set at block 806. If at block 808 a majority of the data values in the current column do not exist in the knowledge base, then no update of the HRG is performed and the column is considered classified at block 812. In some embodiments, in parallel with performing blocks 808, 810, and 812, initializer 702 also performs blocks 814, 816, 818, and 820. In other embodiments, blocks 808, 810, and 812 are performed before blocks 814, 816, 818, and 820, or vice versa. At block 814, Initializer 702 gets a correlation of the current column against other columns of the data set. In an embodiment, all other columns are correlated to the current column. In an embodiment, the correlation comprises a number. At block 816, if the current column meets predetermined criteria for correlation, then Initializer 702 trains the linear regression model (LRM) 710 for the current column at block 818. In an embodiment, the predetermined criteria include being highly correlated to another column. A column may be correlated to one or more other columns and may be sorted in rank order based at least in part on the degree of correlation. For example, if there is a correlation between column A vs. column B, column C, column D, and column E, and the value of each pair may be sorted in a rank order (the correlation of A and C might be highest in terms of correlation, whereas A and E might be second highest, and so on). At block 820, Initializer 702 updates the statistical test relationship graph (STRG) 708 for the correlated columns. In an embodiment, a STRG is a graph with weighted edges that describes relationships among columns. For example, columns A and B might have a correlation value of 0.95, B and C might have a correlation value of 0.85, C and A might have a correlation value of 0.9, and so on. When a user transforms column A, embodiments of the present invention can quickly find out all affected columns and order them by correlation value. As correlations of new columns are determined, the newly determined correlated columns are inserted into the STRG and all relationships as updated. The current column is then considered classified at block 812. If the current column is not highly correlated at block 816, then the LRM is not trained for the current column and processing continues with block 820. At block 806, when all columns of the data set are classified, initialization processing is complete and processing control returns to data prep session 614 at block 822.

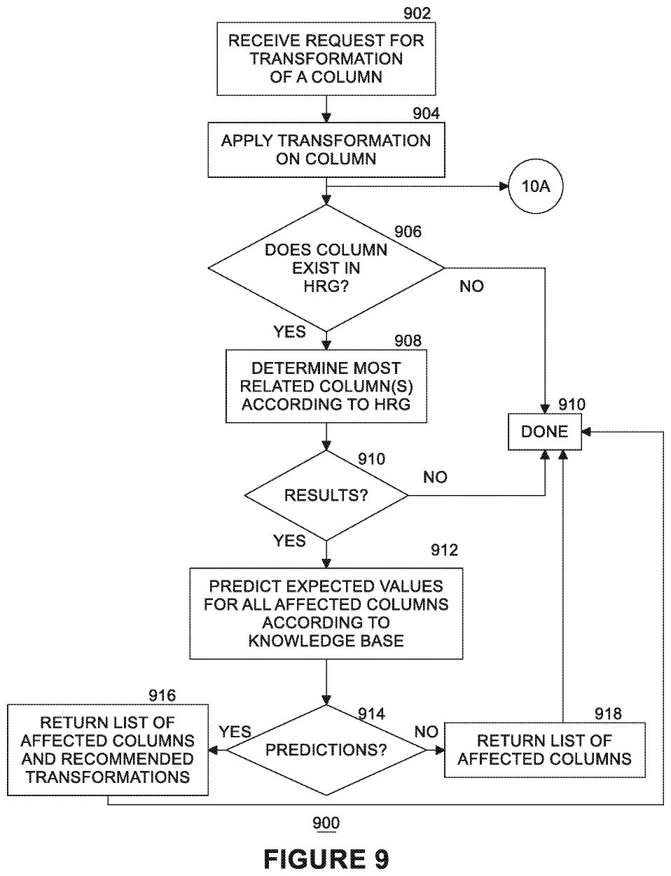

FIG. 9 is a flow diagram 900 of prediction processing according to some embodiments. In an embodiment, the actions of flow diagram 900 are performed by predictor 704 of data prep session 614. At block 902, predictor receives a request for a transformation of a currently selected column of the customer data set 606 from the user. At block 904, predictor 704 applies the transformation on the current column. At block 906, if the current column exists in HRG 706 for the data set, then predictor 704 determines one or more other columns of the data set that are most related to the current column according to HRG 706 (e.g., these columns may be known as affected columns). In embodiments of the present invention, the columns in the HRG are ranked based on a hierarchy. In an embodiment, most related is a relationship between a parent and child in the HRG. For example, if columns represent city, state, and country, with country at the top (or root) of the HRG, a child node is state, and city is a grandchild node. If a user makes a change to the city column, this will result in the state column being returned as the “most” related, followed by the country column. Thus, in one embodiment the most related column is the one with the node in the HRG that is closest to a node of a selected column. If there are columns that meet the criteria of block 908, then at block 912 predictor 704 predicts expected values for data in cells of all affected columns according to knowledge base 706 for each value changed in a cell of the current column as a result of the transformation. If at block 906 there are not columns in the HRG, then processing ends at block 910. If at block 908 there are no related meeting that meet the criteria then processing ends at block 910. After block 912, processing continues with block 914, where predictor 704 determines if any predictions can be made to improve the data in cells of the current column or any affected columns. If there are predictions, then predictor 704 returns a list of the affected columns and recommends transformations to be applied to the affected columns at block 916. Processing then ends at block 910. If there are no predictions, then predictor 704 returns a list of the affected columns (without recommended transformations) at block 918, and processing ends at block 910.

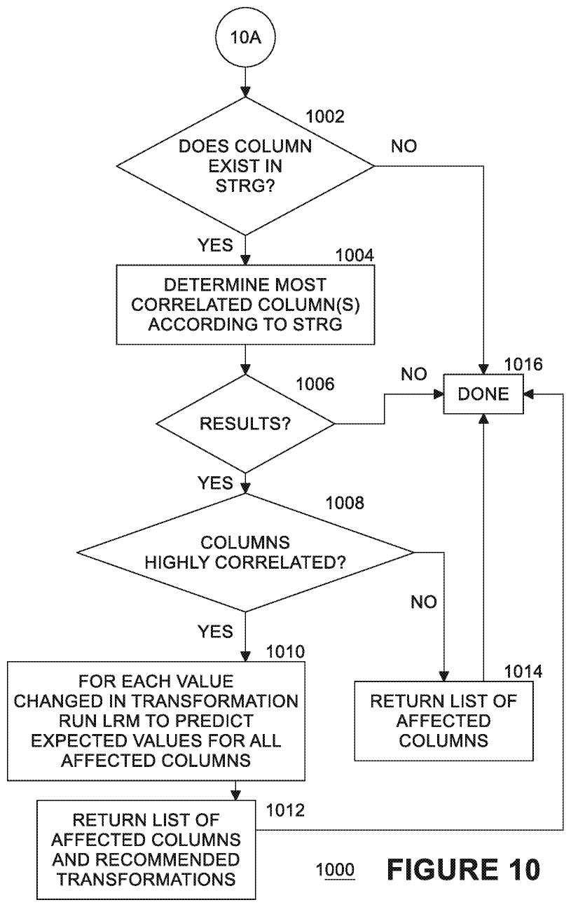

In some embodiments, in parallel with performing blocks 906, 908, 910, 912, 914, 916, and 918, predictor 704 also performs the actions described on FIG. 10. In other embodiments, blocks 906, 908, 910, 912, 914, 916, and 918, are performed before the actions described on FIG. 10, or vice versa.

FIG. 10 is a flow diagram 1000 of prediction processing according to some embodiments. At block 1002, if the current column exists in STRG 708 for the data set, then predictor 704 at block 1004 determines one or more other columns of the data set that are most correlated to the current column according to STRG 708 (e.g., these columns may be known as affected columns). In an embodiment, most correlated is the highest correlation value out of all related columns. For example, if a user made a transformation against column A, and the STRG returns the set [B, D, E] as related columns, and their respective correlation values are [0.3, 0.94, 0.74], then the most correlated column D with a value of 0.94 is returned. If at block 1006 there are columns identified at block 1004, then at block 1008 predictor 704 checks if the identified columns are highly correlated (for example, 0.7 or higher in one embodiment). If at block 1006 there are no columns identified at block 1004, then processing ends at block 1016. If any identified columns are highly correlated, then at block 1010 for each data value changed by the transformation of block 904 run LRM 710 to predict expected values for all cells in all affected columns. Predictions can be applied to the most correlated column on cells that are mutated. Assuming that the model is trained on any correlated columns that have a correlation score of 0.7 and higher, and assuming there are three columns returned by the STRG when user has performed a transformation on column A, in an embodiment the model is run on all three columns, and the result is returned to the user for further selection. At a minimum the highest correlated column is returned with one or more predictions.

At block 1012, predictor 704 returns a list of the affected columns and recommends transformations to be applied to the affected columns. Processing then ends at block 910. If there are no columns that are highly correlated, then predictor 704 returns a list of the affected columns (without recommended transformations) at block 1014, and processing ends at block 1016. If at block 906 there are not columns in the HRG, then processing ends at block 910. If at block 908 there are no related meeting that meet the criteria then processing ends at block 910.

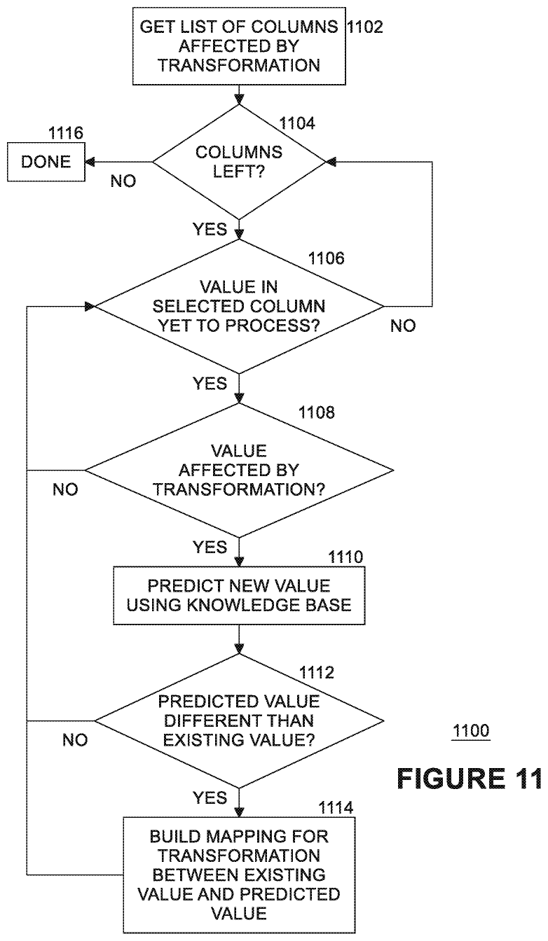

FIG. 11 is a flow diagram 1100 of prediction processing 912 based on a knowledge base 608 according to some embodiments. At block 1102, Predictor 704 gets a list of columns affected by the transformation (output from block 908). Knowledge base prediction processing processes all columns in the list, beginning with a first column in the list of affected columns. At block 1104, if there are columns left to process, then processing continues with block 1106. If there are no more columns left to process, prediction processing ends at block 1116 and processing control returns to block 914 of FIG. 9. At block 1106, for the currently selected column, Predictor 704 processes all data values in cells of the currently selected column, beginning with the first cell. If all cells of the current column have been processed, processing continues with the next affected column at block 1104. If the data value of the current cell at block 1108 is affected by the transformation, Predictor 704 predicts a new value for the current cell at block 1110 using knowledge base 608. If the data value of the current cell is not affected by the transformation, processing continues with the next cell of the current column at block 1106. After block 1110, processing continues with block 1112, where Predictor 704 determines if the predicted value is different than the existing value of the cell. If so, at block 1114 Predictor 704 builds a mapping for the transformation between the existing value and the predicted value. Processing continues with the next cell of the current column at block 1106. If the predicted value is the same as the previous value of the cell, then processing continues with the next cell of the current column at block 1106 (with no change made to the value in the current cell).

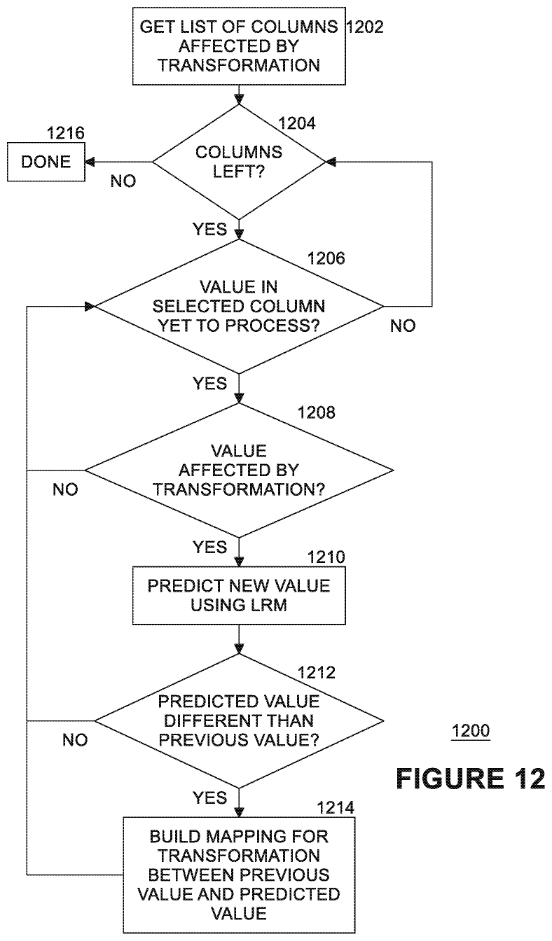

FIG. 12 is a flow diagram 1200 of prediction processing 1010 based on statistical analysis according to some embodiments. At block 1202, Predictor 704 gets a list of columns affected by the transformation (output from block 1004). Statistical analysis prediction processing processes all columns in the list, beginning with a first column in the list of affected columns. At block 1204, if there are columns left to process, then processing continues with block 1206. If there are no more columns left to process, prediction processing ends at block 1216 and processing control returns to block 1012 of FIG. 10. At block 1206, for the currently selected column, Predictor 704 processes all data values in cells of the currently selected column, beginning with the first cell. If all cells of the current column have been processed, processing continues with the next affected column at block 1204. If the data value of the current cell at block 1208 is affected by the transformation, Predictor 704 predicts a new value for the current cell at block 1110 using LRM 710. For example, if user made a change in cell 200 (0x11->0x22) for column A, and assuming A and C have a correlation of 0.98, the model is run on the mutated value of 0x22 for column A to see what the new corresponding value in column C will be. If the predicted value is the same as the current value in C then nothing is changed, if not, a recommendation is recorded.

If the data value of the current cell is not affected by the transformation, processing continues with the next cell of the current column at block 1206. After block 1210, processing continues with block 1212, where Predictor 704 determines if the predicted value is different than the previous value of the cell. If so, at block 1214 Predictor 704 builds a mapping for the transformation between the previous value and the predicted value. Processing continues with the next cell of the current column at block 1206. If the predicted value is the same as the previous value of the cell, then processing continues with the next cell of the current column at block 1206.

Examples of systems, apparatuses, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B, or C” is intended to include the possibilities of “A,” “B,” “C,” “A and B,” “B and C,” “A and C,” and “A, B, and C.”

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

In addition, the articles “a” and “an” as used herein and in the appended claims should generally be construed to mean “one or more” unless specified otherwise or clear from context to be directed to a singular form. Reference throughout this specification to “an implementation,” “one implementation,” “some implementations,” or “certain implementations” indicates that a particular feature, structure, or characteristic described in connection with the implementation is included in at least one implementation. Thus, the appearances of the phrase “an implementation,” “one implementation,” “some implementations,” or “certain implementations” in various locations throughout this specification are not necessarily all referring to the same implementation.

Some portions of the detailed description may be presented in terms of algorithms and symbolic representations of operations on data bits within a computer memory. These algorithmic descriptions and representations are the manner used by those skilled in the data processing arts to most effectively convey the substance of their work to others skilled in the art. An algorithm is herein, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, or otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving,” “retrieving,” “transmitting,” “computing,” “generating,” “adding,” “subtracting,” “multiplying,” “dividing,” “optimizing,” “calibrating,” “detecting,” “performing,” “analyzing,” “determining,” “enabling,” “identifying,” “modifying,” “transforming,” “applying,” “aggregating,” “extracting,” “registering,” “querying,” “populating,” “hydrating,” “updating,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission, or display devices.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which a computing environment is implemented in a system having an application server providing a front end for an on-demand database service capable of supporting multiple tenants, the present implementations are not limited to multi-tenant databases or deployment on application servers. Implementations may be practiced using other database architectures, i.e., ORACLE®, DB2® by IBM, and the like without departing from the scope of the implementations claimed. Moreover, the implementations are applicable to other systems and environments including, but not limited to, client-server models, mobile technology and devices, wearable devices, and on-demand services.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Any of the software components or functions described in this application can be implemented as software code to be executed by one or more processors using any suitable computer language such as, for example, C, C++, Java™ (a trademark of Sun Microsystems, Inc.), or Perl using, for example, existing or object-oriented techniques. The software code can be stored as non-transitory instructions on any type of tangible computer-readable storage medium (referred to herein as a “non-transitory computer-readable storage medium”). Examples of suitable media include random access memory (RAM), read-only memory (ROM), magnetic media such as a hard-drive or a floppy disk, or an optical medium such as a compact disc (CD) or digital versatile disc (DVD), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

The disclosure also relates to apparatuses, devices, and system adapted/configured to perform the operations herein. The apparatuses, devices, and systems may be specially constructed for their required purposes, may be selectively activated or reconfigured by a computer program, or some combination thereof.

In the foregoing description, numerous details are set forth. It will be apparent, however, to one of ordinary skill in the art having the benefit of this disclosure, that the present disclosure may be practiced without these specific details. While specific implementations have been described herein, it should be understood that they have been presented by way of example only, and not limitation. The breadth and scope of the present application should not be limited by any of the implementations described herein, but should be defined only in accordance with the following and later-submitted claims and their equivalents. Indeed, other various implementations of and modifications to the present disclosure, in addition to those described herein, will be apparent to those of ordinary skill in the art from the foregoing description and accompanying drawings. Thus, such other implementations and modifications are intended to fall within the scope of the present disclosure.

Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

What is claimed is:

1. A cloud computing system, comprising:
a processing device; and
a memory device coupled to the processing device, the memory device having instructions stored thereon that, in response to execution by the processing device, cause the processing device to:
receive a request for transformation of data values in one or more cells of a selected column of a data set;
apply the transformation on the selected column;
if the selected column exists in a hierarchical relationship graph, determine zero or more columns of the data set affected by the transformation on the selected column according to the hierarchical relationship graph;
if there are one or more affected columns, predict expected values for cells in the one or more affected columns according to a knowledge base; and
if there are predicted values, return recommended transformations for the affected columns.

2. The cloud computing system of claim 1, wherein the memory device having instructions stored thereon that, in response to execution by the processing device, cause the processing device to:
if the selected column of the data set exists in a statistical test relationship graph, determine zero or more columns of the data set affected by the transformation on the selected column according to the statistical test relationship graph; and
if there are one or more affected columns, run a linear regression model to predict expected values for cells in the one or more affected columns.

3. The cloud computing system of claim 2, wherein the memory device having instructions stored thereon that, in response to execution by the processing device, cause the processing device to:
if there are predicted values, return a list of the affected columns with the recommended transformations for the affected columns; and
if there are no predicted values, return the list of affected columns.

4. The cloud computing system of claim 3, wherein the memory device having instructions stored thereon that, in response to execution by the processing device, cause the processing device to:
receive a request to initialize the data set; and
for selected columns of the data set, if a majority of values in cells of a selected column of the data set exist in the knowledge base, update the hierarchical relationship graph with the selected column.

5. The cloud computing system of claim 4, wherein the memory device having instructions stored thereon that, in response to execution by the processing device, cause the processing device to:
for selected columns of the data set, get a correlation of a selected column against other columns of the data set, and if the correlation meets predetermined criteria, train the linear regression model for the selected column, and update the statistical test relationship graph with correlated columns.

6. The cloud computing system of claim 4, wherein the memory device having instructions to predict expected values for cells in the one or more affected columns according to the knowledge base comprises instructions stored thereon that, in response to execution by the processing device, cause the processing device to:
for selected columns of the list of affected columns and for each value of a cell of a selected column, if the value of the cell of the selected column is affected by the transformation, predict a new value for the cell of the selected column using the knowledge base, and if the predicted new value is different than an existing value of the cell of the selected column, build a mapping for a transformation between the existing value and the predicted new value.

7. The cloud computing system of claim 5, wherein the memory device having instructions to predict expected values for cells in the one or more affected columns according to the linear regression model comprises instructions stored thereon that, in response to execution by the processing device, cause the processing device to:
for selected columns of the list of affected columns and for each value of a cell of a selected column, if the value of the cell of the selected column is affected by the transformation, predict a new value for the cell of the selected column using the linear regression model, and if the predicted new value is different than an existing value of the cell of the selected column, build a mapping for a transformation between the existing value and the predicted new value.

8. A computer-implemented method comprising:
receiving a request for transformation of data values in one or more cells of a selected column of a data set stored in a memory;
applying the transformation on the selected column;
if the selected column exists in a hierarchical relationship graph, determining zero or more columns of the data set affected by the transformation on the selected column according to the hierarchical relationship graph;
if there are one or more affected columns, predicting expected values for cells in the one or more affected columns according to a knowledge base; and
if there are predicted values, return recommended transformations for the affected columns.

9. The method of claim 8, comprising:
if the selected column of the data set exists in a statistical test relationship graph, determining zero or more columns of the data set affected by the transformation on the selected column according to the statistical test relationship graph; and
if there are one or more affected columns, running a linear regression model to predict expected values for cells in the one or more affected columns.

10. The method of claim 9, comprising:
if there are predicted values, returning a list of the affected columns with the recommended transformations for the affected columns; and
if there are no predicted values, returning the list of affected columns.

11. The method of claim 10, comprising:
receiving a request to initialize the data set;
for selected columns of the data set, if a majority of values in cells of a selected column of the data set exist in the knowledge base, updating the hierarchical relationship graph with the selected column.

12. The method of claim 11, comprising:
for selected columns of the data set, getting a correlation of a selected column against other columns of the data set, and if the correlation meets predetermined criteria, training the linear regression model for the selected column, and updating the statistical test relationship graph with correlated columns.

13. The method of claim 11, wherein predicting expected values for cells in the one or more affected columns according to the knowledge base comprises:
for selected columns of the list of affected columns and for each value of a cell of a selected column, if the value of the cell of the selected column is affected by the transformation, predicting a new value for the cell of the selected column using the knowledge base, and if the predicted new value is different than an existing value of the cell of the selected column, building a mapping for a transformation between the existing value and the predicted new value.

14. The method of claim 12, wherein predicting expected values for cells in the one or more affected columns according to the linear regression model comprises:
for selected columns of the list of affected columns and for each value of a cell of a selected column, if the value of the cell of the selected column is affected by the transformation, predicting a new value for the cell of the selected column using the linear regression model, and if the predicted new value is different than an existing value of the cell of the selected column, building a mapping for a transformation between the existing value and the predicted new value.

15. A tangible, non-transitory computer-readable storage medium having instructions encoded thereon which, when executed by a processing device, cause the processing device to:
receive a request for transformation of data values in one or more cells of a selected column of a data set stored in a memory;
apply the transformation on the selected column;
if the selected column exists in a hierarchical relationship graph, determine zero or more columns of the data set affected by the transformation on the selected column according to the hierarchical relationship graph;
if there are one or more affected columns, predict expected values for cells in the one or more affected columns according to a knowledge base; and
if there are predicted values, return recommended transformations for the affected columns.

16. The tangible, non-transitory computer-readable storage medium of claim 15, having instructions encoded thereon which, when executed by a processing device, cause the processing device to:
if the selected column of the data set exists in a statistical test relationship graph, determine zero or more columns of the data set affected by the transformation on the selected column according to the statistical test relationship graph; and
if there are one or more affected columns, run a linear regression model to predict expected values for cells in the one or more affected columns.

17. The tangible, non-transitory computer-readable storage medium of claim 16, having instructions encoded thereon which, when executed by a processing device, cause the processing device to:
if there are predicted values, return a list of the affected columns with the recommended transformations for the affected columns; and
if there are no predicted values, return the list of affected columns.

18. The tangible, non-transitory computer-readable storage medium of claim 17, having instructions encoded thereon which, when executed by a processing device, cause the processing device to:
receive a request to initialize the data set;
for selected columns of the data set, if a majority of values in cells of a selected column of the data set exist in the knowledge base, update the hierarchical relationship graph with the selected column.

19. The tangible, non-transitory computer-readable storage medium of claim 17, having instructions encoded thereon which, when executed by a processing device, cause the processing device to:
for selected columns of the data set, get a correlation of a selected column against other columns of the data set, and if the correlation meets predetermined criteria, train the linear regression model for the selected column, and update the statistical test relationship graph with correlated columns.

20. A processing system comprising:
a hierarchical relationship graph; and
a predictor coupled to the hierarchical relationship graph to receive a request for transformation of data values in one or more cells of a selected column of a data set stored in a memory, apply the transformation on the selected column, if the selected column exists in a hierarchical relationship graph, determine zero or more columns of the data set affected by the transformation on the selected column according to the hierarchical relationship graph; if there are one or more affected columns, predict expected values for cells in the one or more affected columns according to a knowledge base; and if there are predicted values, return recommended transformations for the affected columns.

21. The processing system of claim 20, comprising:
a statistical test relationship graph coupled to the predictor; and
a linear regression model coupled to the predictor;
wherein if the selected column of the data set exists in a statistical test relationship graph, the predictor to determine zero or more columns of the data set affected by the transformation on the selected column according to the statistical test relationship graph; and
wherein if there are one or more affected columns, the predictor run the linear regression model to predict expected values for cells in the one or more affected columns.

22. The processing system of claim 21 wherein the predictor to:
if there are predicted values, return a list of the affected columns with the recommended transformations for the affected columns; and
if there are no predicted values, return the list of affected columns.

23. The processing system of claim 22, comprising:
an initializer coupled to the hierarchical relationship graph, the statistical test relationship graph, and the linear regression model, the initializer to receive a request to initialize the data set; and for selected columns of the data set, if a majority of values in cells of a selected column of the data set exist in the knowledge base, to update the hierarchical relationship graph with the selected column.

24. The processing system of claim 22, for selected columns of the data set, the initializer to get a correlation of a selected column against other columns of the data set, and if the correlation meets predetermined criteria, to train the linear regression model for the selected column, and update the statistical test relationship graph with correlated columns.
